(19) United States
(12) Patent Application Publication
(10) Pub. No.: US 2004/0190788 A1
(43) Pub. Date: Sep. 30, 2004

(54) Image processing apparatus and method

(75) Inventors: Kazuya Imafuku, Kanagawa (JP); Hisashi Ishikawa, Chiba (JP); Makoto Fujiwara, Tokyo (JP); Masao Kato, Kanagawa (JP); Tetsuya Suwa, Kanagawa (JP); Fumitaka Goto, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/809,478

(22) Filed: Mar. 26, 2004

(30) Foreign Application Priority Data
Mar. 31, 2003 (JP) 2003-097186

(51) Int. Cl. G06K 9/40

(52) U.S. Cl. 382/261

(57) ABSTRACT

This invention provides an image processing technique which can reduce low- and high-frequency noise components while suppressing adverse effects such as a resolution drop and the like. A pixel of interest and its surrounding pixels are extracted from input image data (S9001), and the extracted pixels are separated into two categories using the average value of the extracted pixels (S9004). The average pixel values of these categories are calculated (S9005), and a value, which is approximate to the pixel value of the pixel of interest, of the calculated average pixel values of the categories, is output as smoothed data (S9006).

### FIELD OF THE INVENTION

The present invention relates to a technique for reducing noise of image data.

### BACKGROUND OF THE INVENTION

An image sensed by a digital camera or an image optically scanned by a CCD sensor or the like in a scanner or the like contains various kinds of noise, for example, high-frequency noise, and low-frequency noise such as speckle noise or the like.

In order to reduce high-frequency noise of these noise components, a low-pass filter is normally used. In some examples, a median filter is used (e.g., Japanese Patent Laid-Open No. 4-235472).

However, when various filter processes are applied to full image data, not only noise components but also high-frequency components of an image attenuate, thus deteriorating image quality. Also, such various filter processes mainly aim at reducing high-frequency noise, and are not effective to reduce low-frequency noise such as speckle noise or the like.

### SUMMARY OF THE INVENTION

The present invention has been made to solve the aforementioned problems, and has as its object to provide an image processing technique that can reduce low- and high-frequency noise components while minimizing adverse effects such as a resolution drop and the like.

According to one aspect of the present invention, a pixel of interest and its surrounding pixels are extracted from input image data, and respective pixels are separated into two categories using an average value (first average value) of these extracted pixels. Average pixel values (second average values) of the categories are calculated, and one of the calculated average pixel values, which is approximate to the pixel value of the pixel of interest, is output as smoothed data.

According to another aspect of the present invention, it is determined whether or not the pixel of interest belongs to a flat region. If it is determined that the pixel of interest belongs to a flat region, the first average value is output as smoothed data; if it is determined that the pixel of interest does not belong to a flat region, one of the second average values, which is approximate to the pixel value of the pixel of interest, is output as smoothed data.

According to still another aspect of the present invention, an input-image is reduced, a pixel of interest and its surrounding pixels are extracted from the reduced image, and respective pixels are separated into two categories using an average value (first average value) of these extracted pixels. Average pixel values (second average values) of the categories are calculated, and one of the calculated average pixel values, which is approximate to the pixel value of the pixel of interest, is output as smoothed data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a block diagram showing the functional arrangement of an image processing apparatus according to the first embodiment;

FIG. 2 is a block diagram showing the functional arrangement of an image processing apparatus according to the second embodiment;

FIG. 3 is a block diagram showing the functional arrangement of an image processing apparatus according to the third embodiment;

FIG. 4 is a block diagram showing the functional arrangement of an image processing apparatus according to the fourth embodiment;

FIG. 5 is a block diagram showing the functional arrangement of an image processing apparatus according to the fifth embodiment;

FIG. 6 is a block diagram showing the functional arrangement of an image processing apparatus according to the sixth embodiment;

FIG. 7 is a block diagram showing the functional arrangement of an image processing apparatus according to the seventh embodiment;

FIG. 8 is a block diagram showing the functional arrangement of an image processing apparatus according to the eighth embodiment;

FIG. 9 is a flow chart for explaining the operation sequence of the image processing apparatus according to the first embodiment;

FIG. 10 is a flow chart for explaining the operation sequence of the image processing apparatus according to the second embodiment;

FIG. 11 is a flow chart for explaining the operation sequence of the image processing apparatus according to the third embodiment;

FIG. 12 is a flow chart for explaining the operation sequence of the image processing apparatus according to the fourth embodiment;

FIG. 13 is a flow chart for explaining the operation sequence of the image processing apparatus according to each of the fifth to eighth embodiments;

FIG. 14 is a flow chart for explaining the operation sequence of an image processing apparatus according to the ninth embodiment; and

FIG. 15 is a flow chart for explaining an example of the operation sequence of a grayscale value selection process in each of the fifth to ninth embodiments.

### DETAILED DESCRIPTION OF THE PREFERRED EMBODIMENTS

Preferred embodiments of the present invention will now be described in detail in accordance with the accompanying drawings.

### First Embodiment

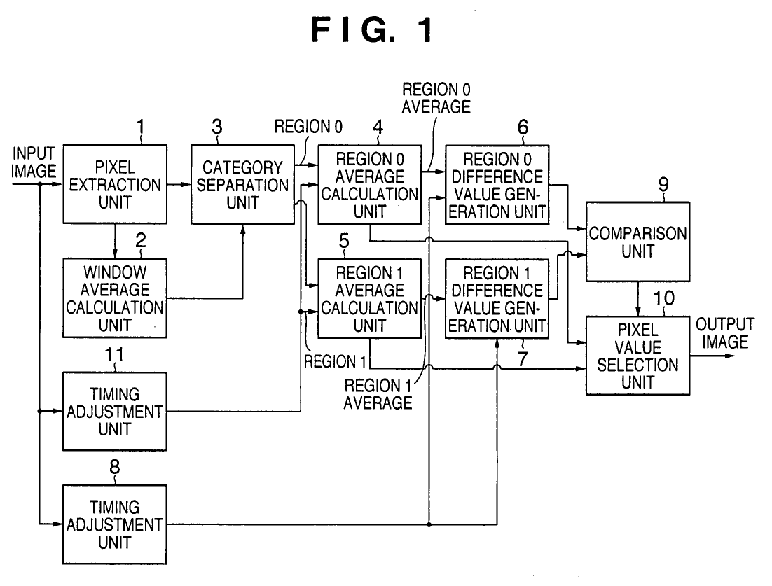

FIG. 1 is a block diagram showing the functional arrangement of an image processing apparatus according to this embodiment. The functional arrangement shown in FIG. 1 can be implemented by either dedicated hardware or software.

Referring to FIG. 1, reference numeral 1 denotes a pixel extraction unit, which extracts a pixel of interest and its surrounding pixels from input image data. In this case, pixels in an n×m (m and n are integers) rectangular region (window region) including the pixel of interest are extracted. The unit 1 passes these pixel values to a window average calculation unit 2 and category separation unit 3.

The window average calculation unit 2 calculates an average value of the pixel values in the window region passed from the pixel extraction unit 1, and passes the average value to the category separation unit 3.

The category separation unit 3 binarizes the respective pixel values in the window region passed from the pixel extraction unit 1 using, as a threshold value, the average value of the pixel values passed from the window average calculation unit 2 to separate the pixel values into categories (region 0 when the pixel value is smaller than the threshold value; region 1 when the pixel value is equal to or larger than the threshold value). The category separation unit 3 outputs pixel position information of pixels in region 0 in the window to a region 0 average calculation unit 4, and outputs pixel position information of pixels in region 1 to a region 1 average calculation unit 5.

Reference numerals 8 and 11 denote timing adjustment units which delay input image data by a time corresponding to latency in respective processing units.

The region 0 average calculation unit 4 extracts pixels from the input image delayed by the timing adjustment unit 11 on the basis of pixel position information of region 0 from the category separation unit 3, calculates an average value of these pixel values, and passes that average value to a region 0 difference value generation unit 6 and pixel value selection unit 10. Likewise, the region 1 average calculation unit 5 extracts pixels from the input image delayed by the timing adjustment unit 11 on the basis of pixel position information of region 1 from the category separation unit 3, calculates an average value of these pixel values, and passes that average value to a region 1 difference value generation unit 7 and the pixel value selection unit 10.

The region 0 difference value generation unit 6 generates the absolute value of a difference between the average value of region 0 passed from the region 0 average calculation unit 4, and an input pixel value of interest delayed by the timing adjustment unit 8, and passes that absolute value to a comparison unit 9. Likewise, the region 1 difference value generation unit 7 generates the absolute value of a difference between the average value of region 1 passed from the region 1 average calculation unit 5, and the input pixel value of interest delayed by the timing adjustment unit 8, and passes that absolute value to the comparison unit 9.

The comparison unit 9 compares the difference values of regions 0 and 1 passed from the region 0 difference value generation unit 6 and region 1 difference value generation unit 7, and passes that comparison result (which of region difference values is smaller) to a pixel value selection unit 10.

The pixel value selection unit 10 outputs the average value of the region with the smaller difference value. That is, when information indicating that the value of region 0 is smaller is passed from the comparison unit 9, the unit 10 outputs the average value of region 0 from the region 0 average calculation unit 4; otherwise, it outputs the average value of region 1 from the region 1 average calculation unit 5.

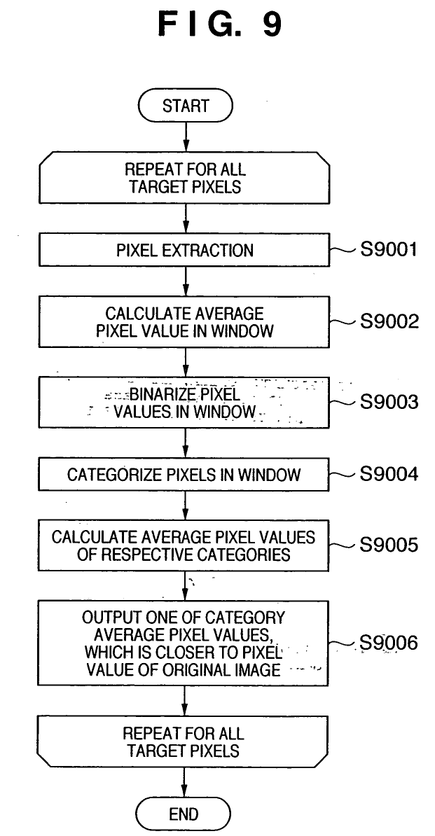

FIG. 9 is a flow chart showing an image smoothing process by the image processing apparatus with the above arrangement.

Note that the process to be described below is individually repeated for all pixels to be smoothed. The pixels to be smoothed need not always be all pixels included in an input image, but may be some pixels of the image. A pixel selection method may vary depending on individual reasons in practical applications.

Also, this process is executed for each signal (plane signal) of an input image. That is, the process is executed individually for R, G, and B signals of an image of an RGB data format, and individually for Y, Cb, and Cr signals of an image of a YCbCr data format.

In the following description, assume that an input image is given in the RGB data format, and R data of the input image is selected as plane data of interest. In practice, this process is also applied to G and B data.

In step S9001, pixels are extracted. In this case, pixels in, e.g., an n×m (n and m are integers) window region are extracted from a pixel to be smoothed and its surrounding pixels.

In step S9002, an average value of the pixel values in the extracted window region is calculated.

In step S9003, pixel data in the window region are binarized using the calculated average value. In this binarization process, each pixel data in the window region is compared with the average value, and 0 or 1 is output depending on that comparison result.

In step S9004, pixels which have a binarization output=0 and those which have a binarization output=1 are separated into two categories, and pixel position information of each category is output.

In step S9005, average values of respective categories are calculated based on the pixel position information of the categories.

In step S9006, differences between these two category average values and the input pixel value of interest are calculated, and the average value of the region which has a smaller difference, i.e., is approximate to the input pixel value of interest, is output.

The effect of the aforementioned smoothing process will be described below.

With the processes in steps S9002 to S9004, respective pixels in the window region are separated into a plurality of categories. Typically, the pixels are separated into two categories using the average value of the pixel values in the window region, as described above.

If the window region includes an edge, pixel values can be separated into two categories to have the edge as a boundary by the process in step S9003. Since the intra-window average value assumes a median of the variation range of pixel values, and pixel values vary largely at an edge portion, the pixel values can be easily separated into two regions using the intra-window average value to have the edge portion as a boundary.

By calculating the average values of respective categories in step S9005, high-frequency noise can be reduced. Also, by calculating the average values of respective categories (step S9005), calculating the differences between these average values and input image data in step S9006, and selecting the average value of the category with the smaller difference value, a good smoothing result which has correlation with the input image and minimizes a blur of an edge portion and the like can be obtained. When a process is done using an average value calculated without any categorization as in the conventional method, an edge portion is excessively smoothed.

As described above, according to this embodiment, smoothing can be satisfactorily made while suppressing adverse effects such as a resolution drop and the like (especially, a blur of an edge portion), and high-frequency noise and low-frequency noise can be reduced.

As for the window size in step S9001, extracting pixels within a broader range means smoothing using pixel data within a broader range. In order to reduce speckle low-frequency noise, smoothing must be done using data over a broad range. However, the size of the range from which data are to be extracted and processed varies depending on the speckle size. If a process is done using data within an excessively broad range, over-smoothing takes place. Also, noise characteristics (speckle size and the like) of noise added to each plane vary depending on, e.g., the CCD characteristics, and human vision, i.e., perception of a blur caused by smoothing, also varies depending on planes. For these reasons, it is preferable to individually set the pixel extraction range for each plane (R, G, B). Data to be used for each plane must be set in consideration of a degree of reduction of low-frequency noise, adverse effects on an image, and the like, and this extraction range is empirically set based on an actual processing result and the like.

In this manner, it is preferable to individually set a data range to be used in smoothing for each plane. As a result, low-frequency noise can be reduced more effectively.

### Second Embodiment

The first embodiment aims at obtaining a satisfactory smoothing result without excessively smoothing an edge especially when the window region includes the edge. However, stronger smoothing is preferably applied to a flat region where no edge is present in the window region. Hence, the second embodiment switches a smoothing process depending on whether or not a pixel of interest belongs to a flat portion.

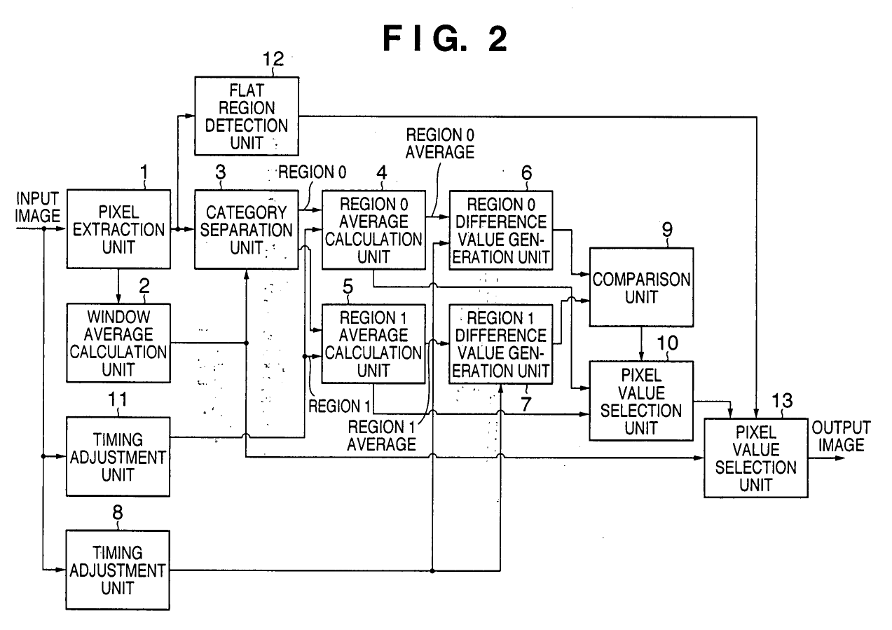

FIG. 2 is a block diagram showing the functional arrangement of an image processing apparatus according to this embodiment. Since the arrangement shown in FIG. 2 includes many parts common to those in FIG. 1, the same reference numerals in FIG. 2 denote the same parts as those in FIG. 1, and a description thereof will be omitted. Differences from FIG. 1 will be described below.

The arrangement shown in FIG. 2 is different from that in FIG. 2 in that a flat region detection unit 12 and a second pixel value selection unit 13 are added.

The flat region detection unit 12 determines using the pixel values in the window passed from the pixel extraction unit 1 whether or not the pixel of interest belongs to a flat portion, and passes information of that determination result to the second pixel value selection unit 13. As the method of determining whether or not the pixel of interest belongs to a flat portion, the following methods can be used in practice.

In the first embodiment, the range (difference between the maximum and minimum values) of the pixel values in the window passed from the pixel extraction unit 1 undergoes a threshold value process. That is, if the range is equal to or smaller than a given threshold value, a flat portion is determined; otherwise, a non-flat portion is determined. This method is attained by a light process since it directly evaluates variations of pixel data.

In the second method, the difference value between the second largest pixel value and second smallest pixel value in the window passed from the pixel extraction unit 1 undergoes a threshold value process. With this method, variations of pixel data which do “not blunt” by smoothing can be evaluated while suppressing the influence of high-frequency noise to some extent.

In the third embodiment, the difference value between the category average values calculated by the region 0 average calculation unit 4 and region 1 average calculation unit 5 is used. In this case, since it is determined using the average values if the extracted pixel range belongs to a flat portion, robust determination free from the influence of high-frequency noise can be made, as long as a relatively large number of pixels are used. However, this method requires to change the connection arrangement shown in FIG. 2 to input the category average values from the region 0 average calculation unit 4 and region 1 average calculation unit 5.

The second pixel value selection unit 13 is connected to the output side of the first pixel value selection unit 10, and selects one of the outputs from the window average calculation unit 2 and first pixel value selection unit 10 as an output value on the basis of information which is passed from the flat region detection unit 12 and indicates whether or not the pixel of interest belongs to a flat portion. More specifically, if the pixel of interest belongs to a flat portion, the unit 13 outputs the intra-window average value (i.e., the average value without using category separation) passed from the window average calculation unit 2; otherwise, it outputs the average value according to the first embodiment that uses category separation.

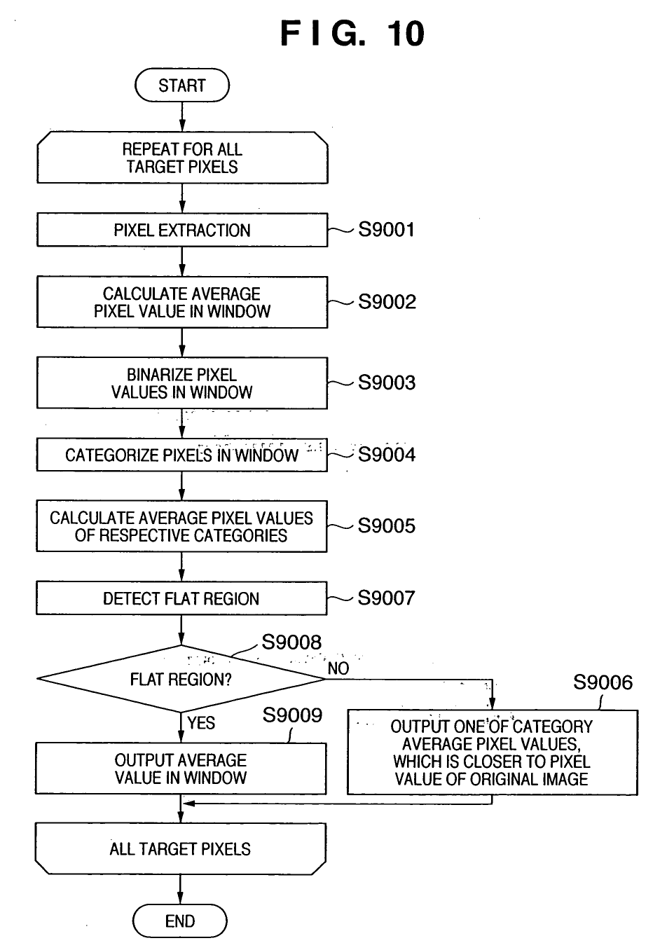

FIG. 10 is a flow chart showing an image smoothing process by the image processing apparatus with the arrangement shown in FIG. 2. Since steps S9001 to S9006 are the same as those in the flow chart of FIG. 9 in the first embodiment, a description thereof will be omitted. As in the first embodiment, assume that an input image is given in the RGB data format, and R data of the input image is selected as plane data of interest. In practice, this process is also applied to G and B data.

After the average pixel values of the categories are calculated in step S9005, the flat region detection unit 12 detects in step S9007 if the pixel of interest belongs to a flat portion. In this case, the range of the pixel values in the window region extracted in step S9001 undergoes a threshold value process to determine if the pixel of interest belongs to a flat portion. Of course, the difference value between the second largest value and second smallest value or the difference value of the category average values obtained in step S9005 may be used instead of the range (the difference value between the maximum and minimum values) of the pixel values in the window region, as described above.

In step S9008, the next process is switched based on the information which is passed from step S9007 and indicates whether or not the pixel of interest belongs to a flat portion. If the pixel of interest belongs to a flat portion, the window average value (without using category separation) is output in step S9009; otherwise, data obtained in step S9005, i.e., one of the category average pixel values, which is closer to the input pixel of interest, is output in step S9006.

The effect of the aforementioned smoothing process will be explained below.

In this embodiment, when it is determined using the flat region detection information that the pixel of interest belongs to a flat portion, a simple window average value is output as smoothed data; when it is determined that the pixel of interest does not belong to a flat portion, one of the category average values, which is closer to the pixel of interest, is output as average value. In this manner, the flat portion can undergo smoothing using more pixel data, i.e., pixel data in a broader range. Since various noise components added to an image are especially conspicuous in a flat region, a process that can enhance the smoothing level can be implemented. Therefore, according to this embodiment, a flat portion can undergo stronger low-frequency noise reduction while holding an edge.

### Third Embodiment

The third embodiment can reduce the number of pixel data to be referred to while maintaining the noise reduction effect of the first embodiment.

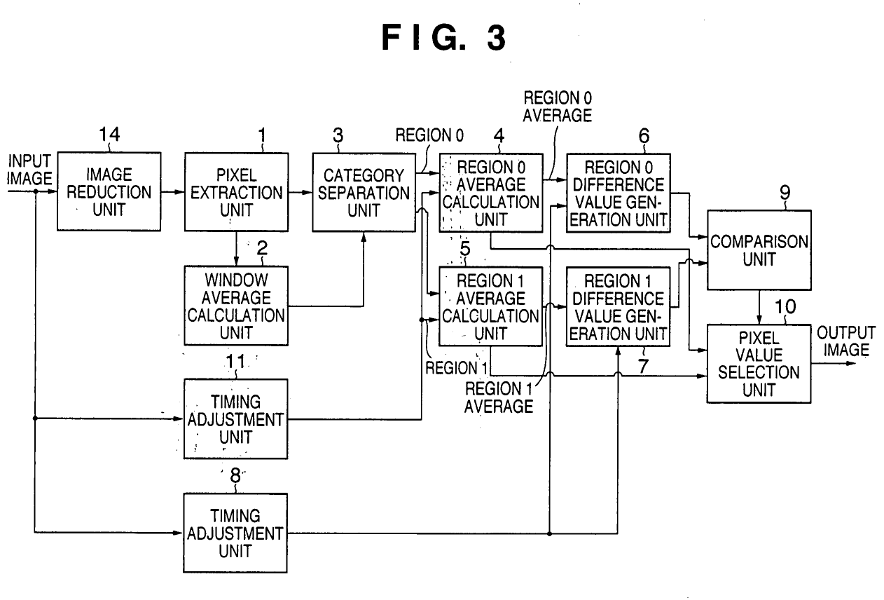

FIG. 3 is a block diagram showing the functional arrangement of an image processing apparatus according to this embodiment. Since the arrangement shown in FIG. 3 includes many parts common to those in FIG. 1, the same reference numerals in FIG. 3 denote the same parts as those in FIG. 1, and a description thereof will be omitted. Differences from FIG. 1 will be described below.

Unlike in the arrangement shown in FIG. 1, an image reduction unit 14 that reduces input image data is inserted before the pixel extraction unit 1. As an image reduction process in the image reduction unit 14, for example, the average value in a k×1 (k and 1 are integers) window region according to an image reduction scale may be calculated, and may be used as one pixel value of a reduced image, or another algorithm that can calculate such value using a plurality of pixel values may be used. However, it is not preferable to reduce an image by simple pixel decimation. This is because high-frequency noise reduction using a reduced image cannot be expected.

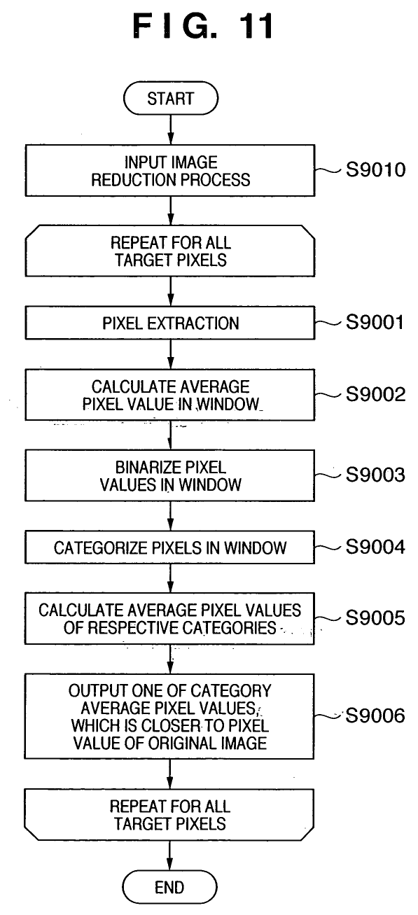

An image smoothing process by the image processing apparatus with the above arrangement is as shown in the flow chart of FIG. 11. The flow chart in FIG. 11 is substantially the same as that of FIG. 9 in the first embodiment, except that an input image reduction process is executed first in step S9010, and the subsequent processes are done using reduced image data. Note that smoothed image data obtained in step S9006 is output to have the same resolution as that of the input image in practice. That is, when each category average value and input pixel value are compared in step S9006, each category average value obtained from the reduced image region, and respective pixel values of the input image corresponding to that position are compared repetitively.

The effect of this embodiment is as follows.

In this embodiment, since the input image is reduced using the window region average value or the like in place of simple pixel decimation, high-frequency noise added to an image can be eliminated. Then, the process corresponding to the first embodiment is done using reduced image data. Therefore, pixel extraction using the reduced image region is equivalent to that using data in a broader range even when data are actually extracted from a narrower range. That is, the number of pixel data to be referred to at the same time can be reduced, and the reference range can be narrowed down. In this manner, even when a pixel reference window is limited, data in a broader range can be used.

Since smoothed output data of the first embodiment is the average value obtained from a plurality of pixel data, the performance of the noise reduction method according to the first embodiment can be maintained depending on a reduction method to be used. This extraction range can also be empirically set based on an actual processing result and the like as in the first embodiment.

Conventionally, upon enlarging a reduced image to, e.g., an input image size, an enlarged image is obtained using enlarged image data, e.g., some interpolation function or the like since input image data is not available in such case. However, the present invention executes reduction and enlargement steps for the purpose of enlargement of a reference range or the like upon obtaining a smoothed image used to reduce noise. Since original image data is also held, the present invention can use that data upon enlargement. That is, a result faithful to original image data can be obtained compared to the conventional enlargement method.

As described above, a process that can reduce the number of pixels to be referred to at the same time, i.e., the required memory size using a reduced image while maintaining the noise reduction effect of the first embodiment can be implemented. Also, the image reduction process itself can also serve as a high-frequency noise reduction process.

### Fourth Embodiment

In the fourth embodiment, the third embodiment is applied to the second embodiment. That is, a smoothing process according to the third embodiment and another smoothing process are switched depending on whether or not the pixel of interest belongs to a flat portion.

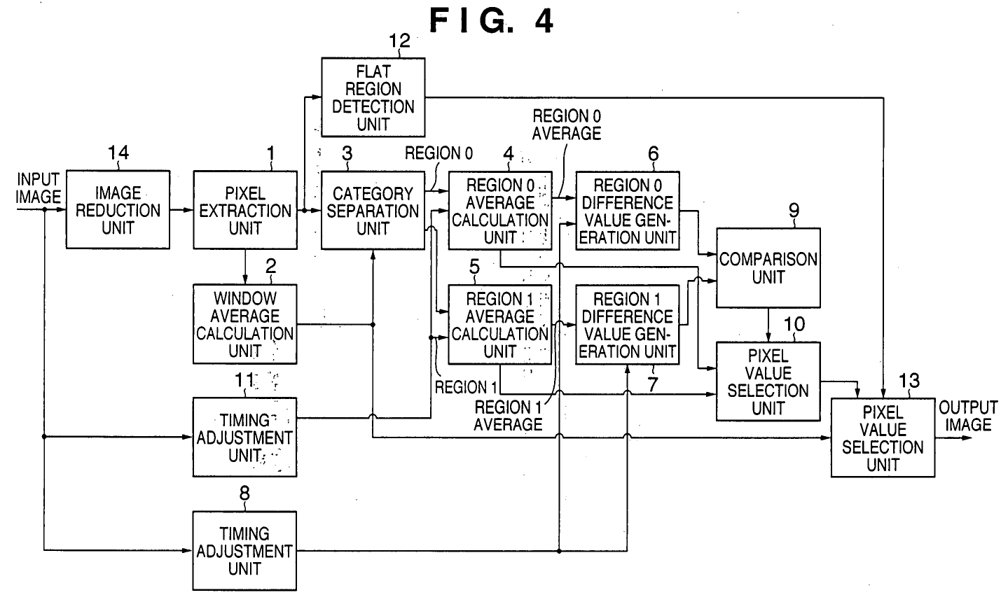

FIG. 4 is a block diagram showing the functional arrangement of an image processing apparatus according to the fourth embodiment. Unlike in the arrangement shown in FIG. 3, a flat region detection unit 12 and a second pixel value selection unit 13 are added. In other words, an image reduction unit 14 that reduces input image data is inserted before the pixel extraction unit 1 in the arrangement of FIG. 2 as the second embodiment.

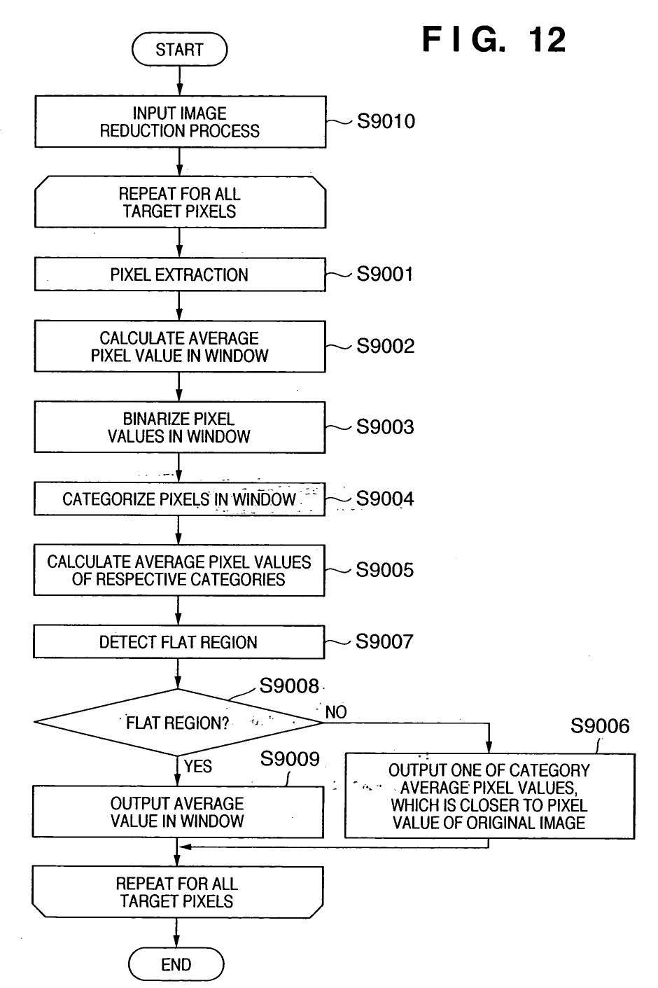

An image smoothing process by the image processing apparatus with the above arrangement is as shown in the flow chart of FIG. 12, and is substantially the same as that of FIG. 10 in the first embodiment, except that an input image reduction process is executed first in step S9010, and the subsequent processes are done using reduced image data. Note that smoothed image data obtained in step S9006 is output to have the same resolution as that of the input image in practice. That is, when each category average value and input pixel value are compared in step S9006, each category average value obtained from the reduced image region, and respective pixel values of the input image corresponding to that position are compared repetitively.

In this manner, in addition to the effect of the third embodiment, a stronger low-frequency noise reduction process can be applied to a flat portion while holding an edge.

### Fifth Embodiment

The fifth embodiment selects one of the output value according to the first embodiment and an input pixel value as a final output value, thus obtaining a more visually satisfactory noise reduction result while minimizing adverse effects such as an edge blur and the like.

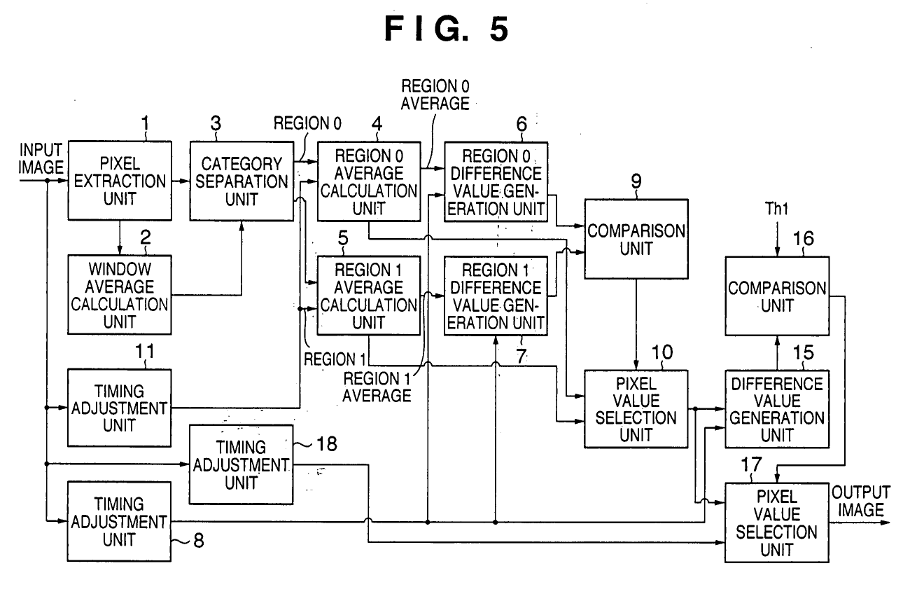

FIG. 5 is a block diagram showing the functional arrangement of an image processing apparatus according to this embodiment. Since the arrangement shown in FIG. 5 includes many parts common to those in FIG. 1, the same reference numerals in FIG. 5 denote the same parts as those in FIG. 1, and a description thereof will be omitted. Differences from FIG. 1 will be described below.

A difference value generation unit 15 generates a difference value between an input pixel value which is delayed by a timing adjustment unit 18 by a time corresponding to latency in respective processing units, and smoothed data which is passed from the pixel value selection unit 10 and is obtained according to the first embodiment, and passes that difference value to a comparison unit 16.

The comparison unit 16 compares the difference value passed from the difference value generation unit 15 with a predetermined threshold value Th1, and passes information indicating whether or not that difference value is equal to or larger than the threshold value to a third pixel value selection unit 17.

The third pixel value selection unit 17 selects, as an output, the smoothed data obtained according to the first embodiment, and the input pixel value delayed by the timing adjustment unit 18, on the basis of the information passed from the comparison unit 16. More specifically, when the information indicating that the difference value between the input pixel value delayed by the timing adjustment unit 18, and the smoothed data which is obtained according to the first embodiment and is passed from the pixel value selection unit 10 is equal to or larger than the threshold value is passed from the comparison unit 16, the unit 17 outputs the input pixel value delayed by the timing adjustment unit 18. On the other hand, when the information indicating that the difference value is smaller than the threshold value is passed from the comparison unit 16, the unit 17 outputs the smoothed data which is obtained according to the first embodiment and is passed from the pixel value selection unit 10.

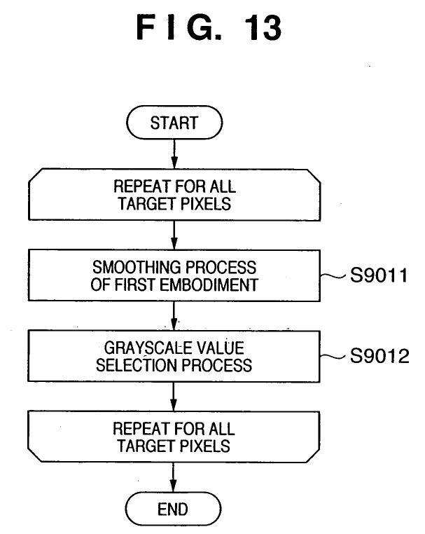

FIG. 13 is a flow chart showing an image smoothing process according to this embodiment. In step S9011, the process according to the first embodiment is executed. In step S9012, the difference value between the smoothed data obtained in step S9011 and corresponding input image data undergoes a threshold value process, and data to be output is selected depending on whether or not the difference value is equal to or larger than the threshold value.

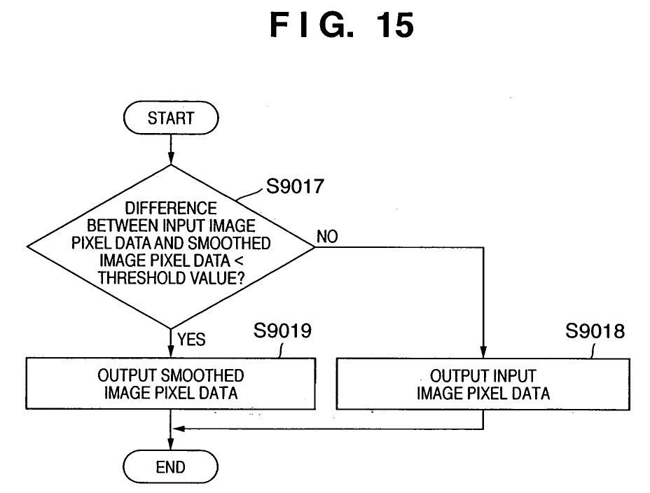

FIG. 15 is a flow chart showing details of the process in step S9012. In step S9017, the difference value between input image data and smoothed data obtained in step S9011 is compared with the threshold value. If the difference value is equal to or larger than the threshold value, input image data is output in step S9018; otherwise, the smoothed data obtained in step S9011 is output in step S9019.

Note that the threshold value process in step S9012 is independently executed for respective pixels and planes. This is because the noise reduction process must be done for respective planes since noise components added to image data obtained via a CCD in a digital camera or the like have no correlation among planes.

In this way, since the process is independently done for respective planes, the smoothing level can be switched depending on planes. That is, this embodiment can adjust a process to maintain input image data as much as possible for a plane in which noise is not so conspicuous.

### Sixth Embodiment

In the sixth embodiment, the aforementioned fifth embodiment is applied to the second embodiment. That is, one of smoothed data according to the second embodiment and input image data is selected according to the difference value between them.

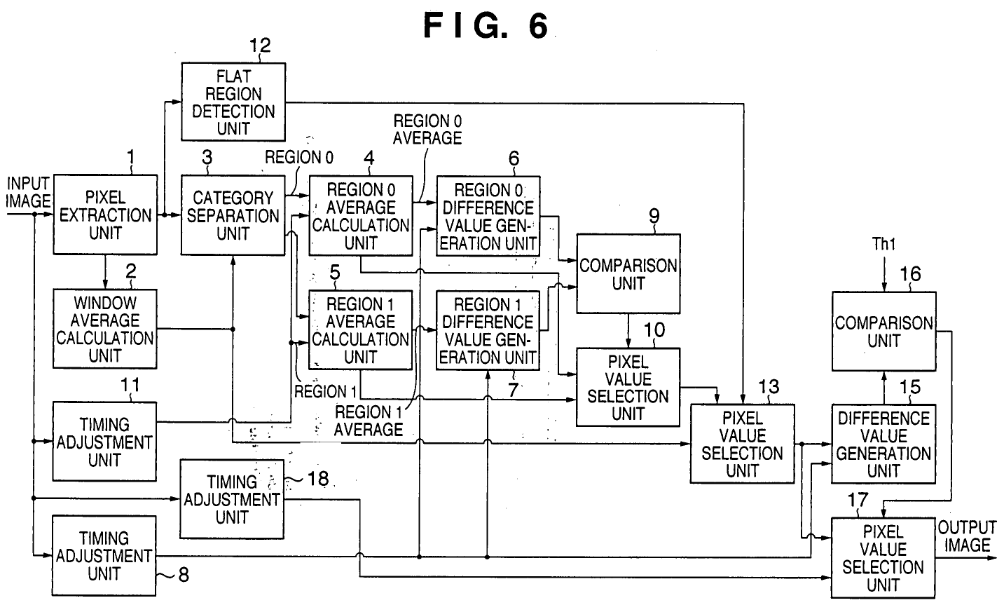

FIG. 6 is a block diagram showing the functional arrangement of an image processing apparatus according to this embodiment. In FIG. 6, a difference value generation unit 15, comparison unit 16, third pixel value selection unit 17, and timing adjustment unit 18 are further added to the arrangement shown in FIG. 5, which also includes a flat region detection unit 12 and second pixel value selection unit 13 in addition to the original arrangement.

With this arrangement, the process according to the flow charts of FIGS. 13 and 15 described above can be similarly applied. However, the “smoothing process of the second embodiment” is executed in step S9011.

According to this embodiment, the smoothing level can be switched for respective planes by independently execute the process for respective planes, as described in the fifth embodiment. In addition, the following effect can be obtained.

Upon determining one of the smoothed data or input image data to be output by the threshold value process in step S9012, the threshold value is adjusted to output more pixels of original image data near an edge of an image, thus changing the reproduction level of the edge. In case of this embodiment, the flat region detection result in step S9007 (see FIG. 10) included in step S9011 can be used in this process. For a pixel which is determined as a non-flat portion, a threshold value used in the threshold value process is set to be smaller than that for a pixel which is determined as a flat portion, so that input image data is more likely to be output, thus holding edge information.

Conversely, for a flat region, a larger threshold value is set to output smoothed data with higher possibility, thus enhancing the smoothing level, and attaining further noise reduction.

By changing the threshold value on the basis of a plane, image flat information, and the like in consideration of the CCD noise characteristics and characteristics of noise which is more conspicuous on a flat region, a further noise reduction effect can be obtained.

As for this method, an example using the flat region extraction result of an image has been described. In addition, it is effective to take notice of the following points. More specifically, the following setup is made.

Since noise tends to be especially added to a specific plane depending on CCD noise characteristics, a large threshold value is set in step S9017 to easily select noise reduction data for that plane.

The above facts are particularly important when a JPEG image is handled as an input image. This is for the following reason. That is, since many high-frequency signal components of image data are cut off during an encoding process of a JPEG image, high-frequency noise is removed at that time, and how to hold remaining high-frequency components is important upon processing this image data. This embodiment is very effective for JPEG image data since high-frequency noise is smoothed not strongly, but smoothing focused on low-frequency noise can be applied while holding high-frequency components.

Since a plurality of smoothed data are prepared for a non-flat portion, adverse effects such as an edge blur and the like can be suppressed even when smoothed data are output up to the vicinity of an edge. In addition, switching of an original image data selected portion and smoothed data selected portion at a boundary between the edge and flat portion can be obscured.

If the threshold value in step S9017 (see FIG. 5) changes abruptly between a flat portion and edge portion, a switching portion between a region that adopts noise reduction image data and a region that adopts original image data may become conspicuous. Such phenomenon can be prevented by inhibiting the threshold value from being abruptly switched.

### Seventh Embodiment

In the seventh embodiment, the fifth embodiment is applied to the third embodiment.

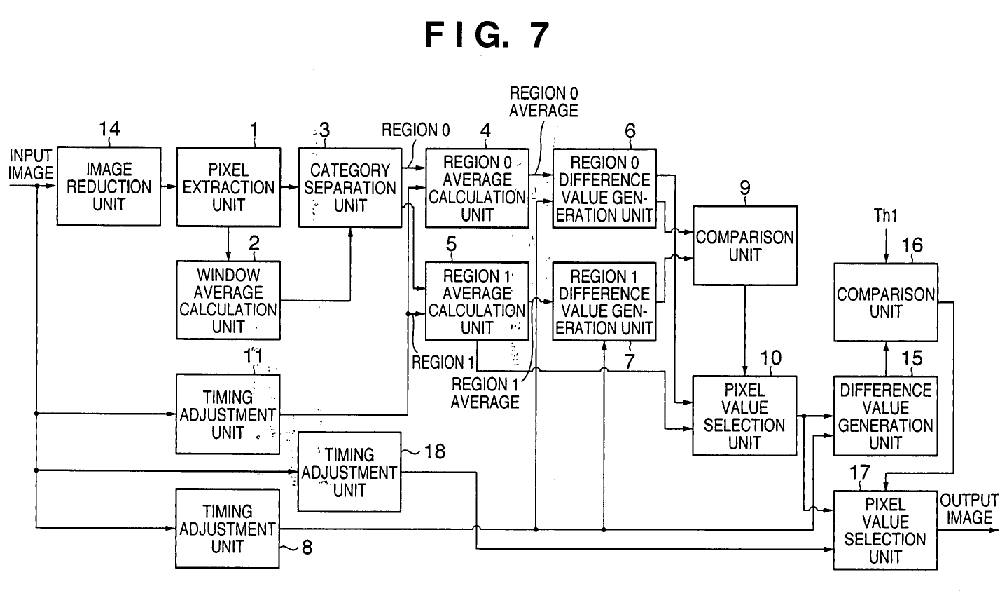

FIG. 7 is a block diagram showing the functional arrangement of an image processing apparatus according to this embodiment. Unlike in the arrangement shown in FIG. 1, an image reduction unit 14 that reduces input image data is inserted before the pixel extraction unit 1.

As can be understood from the above description, with this embodiment, an input image reduction process (e.g., step S9010 in FIG. 12) is executed, and the process shown in FIG. 13 is done using reduced image data. Note that the “smoothing process of the third embodiment” is executed in step S9011.

According to this embodiment, the smoothing level can be switched for respective planes by independently executing the process for respective planes, as described in the fifth embodiment. In addition, high-frequency noise can be reduced, and the number of pixel data to be referred to at the same time can also be reduced.

### Eighth Embodiment

In the eighth embodiment, the fifth embodiment is applied to the fourth embodiment.

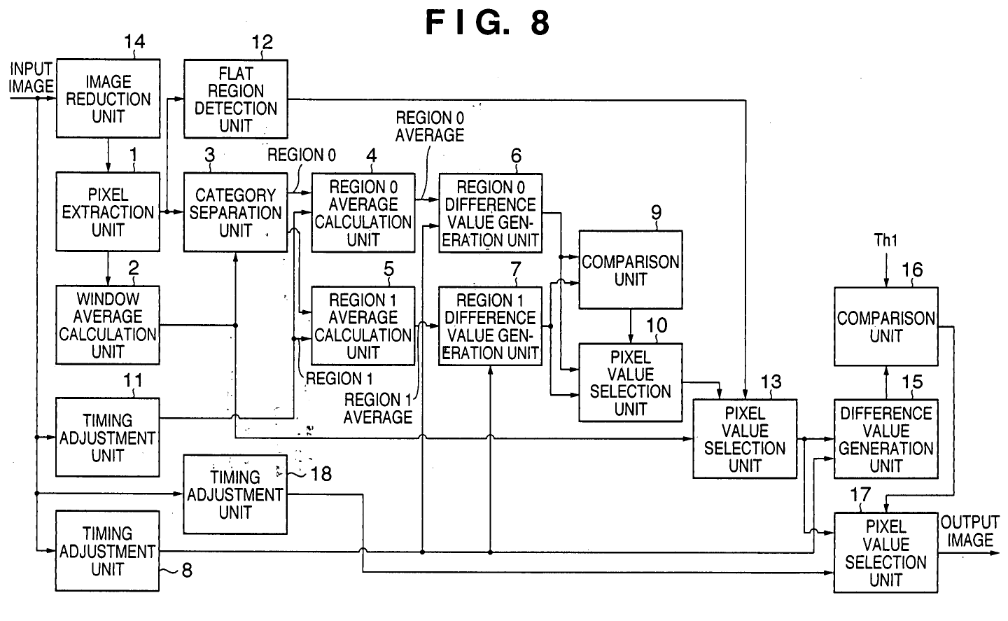

FIG. 8 is a block diagram showing the functional arrangement of an image processing apparatus according to this embodiment. Unlike in the arrangement shown in FIG. 6, an image reduction unit 14 that reduces input image data is inserted before the pixel extraction unit 1.

As can be understood from the above description, with this embodiment, an input image reduction process (e.g., step S9010 in FIG. 12) is executed, and the process shown in FIG. 13 is done using reduced image data. Note that the “smoothing process of the fourth embodiment” is executed in step S9011.

According to this embodiment, the smoothing level can be switched for respective planes by independently executing the process for respective planes, as described in the fifth embodiment. In addition, high-frequency noise can be reduced, and the number of pixel data to be referred to at the same time can also be reduced. Furthermore, a stronger low-frequency noise reduction process can be applied to a flat portion while holding an edge.

### Ninth Embodiment

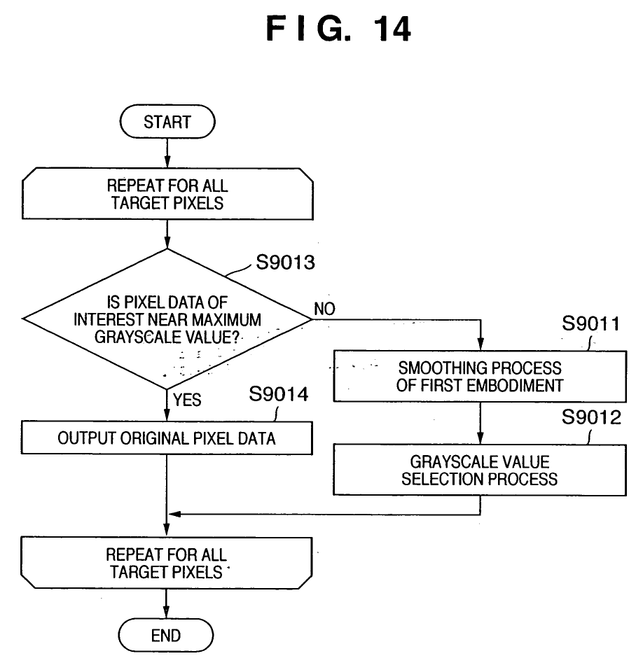

In the fifth to eighth embodiments described above, an image smoothing process shown in the flow chart of FIG. 14 may be applied in place of the flow chart shown in FIG. 13.

Referring to FIG. 14, it is checked in step S9013 if input image data is near a maximum grayscale value. If it is determined that input image data is near a maximum grayscale value, input image data is output in step S9014. Otherwise, a corresponding smoothing process of one of the first to fourth embodiments is executed in step S9011, and a grayscale value selection process is executed in step S9012.

The effect of such image smoothing process is as follows.

The smoothing process and noise reduction process according to the first to third embodiments described above execute smoothing using data in a broad range so as to reduce low-frequency noise. For this reason, various adverse effects may occur. For example, dots may be formed even on a region of an input image, where no dots are generated upon application of an error diffusion process or the like for a print process, since that region assumes a maximum grayscale value. Originally, since a highlight portion is a region where dots are rarely formed even when it undergoes various processes for a print process, a slight increase in number of print dots is recognized as an adverse effect. Hence, like in this embodiment, for a pixel of input image data, which assumes a maximum grayscale value or a value near it, input image data is output intact in step S9014, thus preventing such adverse effects.

According to the above embodiments of the present invention, both high- and low-frequency noise components added to image data can be reduced.

Although smoothing is used in a noise reduction process, edge information of image data can be held.

Since original image data is held, it is used for a region such as an edge region which includes many high-frequency components in a grayscale value selection process in the noise reduction process. Hence, the resolution of image data can be maintained at a desired level.

Also, a process using a reduced image is nearly equivalent to that without using any reduced image, if a reduction scale falls within a given range. That is, the processing amount can be reduced while maintaining a noise reduction effect.

Furthermore, since a reduced image is used, the number of pixel data to be referred to at the same time can be reduced for the same reason as described above while maintaining the noise reduction effect. In addition, upon referring to data in a broad range, the reference range can be narrowed down.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus for executing a smoothing process of image data, comprising:
extraction means for extracting a pixel of interest and surrounding pixels thereof from input image data;
first average value calculation means for calculating an average value of the pixels extracted by said extraction means;
separation means for separating the pixels extracted by said extraction means into two categories using the average value calculated by said first average value calculation means;
second average value calculation means for calculating average pixel values of the two categories;. and
output means for outputting a value, which is approximate to a pixel value of the pixel of interest, of the average pixel values of the two categories calculated by said second average value calculation means.

2. An image processing apparatus for executing a smoothing process of image data, comprising:
extraction means for extracting a pixel of interest and surrounding pixels thereof from input image data;
first average value calculation means for calculating an average value of the pixels extracted by said extraction means;
separation means for separating the pixels extracted by said extraction means into two categories using the average value calculated by said first average value calculation means;
second average value calculation means for calculating average pixel values of the two categories;
determination means for determining whether or not the pixel of interest belongs to a flat region; and
output means for, when said determination means determines that the pixel of interest belongs to a flat region, outputting the average value calculated by said first average value calculation means as smoothed data, and for, when said determination means determines that the pixel of interest does not belong to a flat region, outputting a value, which is approximate to a pixel value of the pixel of interest, of the average pixel values of the two categories calculated by said second average value calculation means.

3. An image processing apparatus for executing a smoothing process of image data, comprising:
image reduction means for reducing an input image;
extraction means for extracting a pixel of interest and surrounding pixels thereof from the image reduced by said image reduction means;
first average value calculation means for calculating an average value of the pixels extracted by said extraction means;
separation means for separating the pixels extracted by said extraction means into two categories using the average value calculated by said first average value calculation means;
second average value calculation means for calculating average pixel values of the two categories; and
output means for outputting a value, which is approximate to a pixel value of the pixel of interest, of the average pixel values of the two categories calculated by said second average value calculation means.

4. An image processing apparatus for executing a smoothing process of image data, comprising:
image reduction means for reducing an input image;
extraction means for extracting a pixel of interest and surrounding pixels thereof from the image reduced by said image reduction means;
first average value calculation means for calculating an average value of the pixels extracted by said extraction means;
separation means for separating the pixels extracted by said extraction means into two categories using the average value calculated by said first average value calculation means;
second average value calculation means for calculating average pixel values of the two categories;
determination means for determining whether or not the pixel of interest belongs to a flat region; and
output means for, when said determination means determines that the pixel of interest belongs to a flat region, outputting the average value calculated by said first average value calculation means as smoothed data, and for, when said determination means determines that the pixel of interest does not belong to a flat region, outputting a value, which is approximate to a pixel value of the pixel of interest, of the average pixel values of the two categories calculated by said second average value calculation means.

5. The apparatus according to claim 1, further comprising:
selection means for selecting one of the value output by said output means and the pixel value of the pixel of interest in accordance with a difference value between the value output by said output means and the pixel value of the pixel of interest.

6. An image processing method for executing a smoothing process of image data, comprising the steps of:
(a) extracting a pixel of interest and surrounding pixels thereof from input image data;
(b) calculating an average value of the pixels extracted in the step (a);
(c) separating the pixels extracted in the step (a) into two categories using the average value calculated in the step (b);
(d) calculating average pixel values of the two categories; and
(e) outputting a value, which is approximate to a pixel value of the pixel of interest, of the average pixel values of the two categories calculated in the step (d).

7. An image processing method for executing a smoothing process of image data, comprising the steps of:
(a) extracting a pixel of interest and surrounding pixels thereof from input image data;
(b) calculating an average value of the pixels extracted in the step (a);
(c) separating the pixels extracted in the step (a) into two categories using the average value calculated in the step (b);
(d) calculating average pixel values of the two categories;
(e) determining whether or not the pixel of interest belongs to a flat region; and
(f) outputting, when it is determined in the step (e) that the pixel of interest belongs to a flat region, the average value calculated in the step (b) as smoothed data, and outputting, when it is determined in the step (e) that the pixel of interest does not belong to a flat region, a value, which is approximate to a pixel value of the pixel of interest, of the average pixel values of the two categories calculated in the step (d).

8. An image processing method for executing a smoothing process of image data, comprising the steps of:
(a) reducing an input image;
(b) extracting a pixel of interest and surrounding pixels thereof from the image reduced in the step (a);
(c) calculating an average value of the pixels extracted in the step (b);
(d) separating the pixels extracted in the step (b) into two categories using the average value calculated in the step (c);
(e) calculating average pixel values of the two categories; and
(f) outputting a value, which is approximate to a pixel value of the pixel of interest, of the average pixel values of the two categories calculated in the step (e).

9. An image processing method for executing a smoothing process of image data, comprising:
(a) reducing an input image;
(b) extracting a pixel of interest and surrounding pixels thereof from the image reduced in the step (a);
(c) calculating an average value of the pixels extracted in the step (b);
(d) separating the pixels extracted in the step (b) into two categories using the average value calculated in the step (c);
(e) calculating average pixel values of the two categories;
(f) determining whether or not the pixel of interest belongs to a flat region; and
(g) outputting, when it is determined in the step (f) that the pixel of interest belongs to a flat region, the average value calculated in the step (c) as smoothed data, and outputting, when it is determined in the step (f) that the pixel of interest does not belong to a flat region, a value, which is approximate to a pixel value of the pixel of interest, of the average pixel values of the two categories calculated in the step (e).

10. The method according to claim 6, further comprising the step of:
(f) selecting one of the value output in the step (e) and the pixel value of the pixel of interest in accordance with a difference value between the value output in the step (e) and the pixel value of the pixel of interest.

11. Computer executable program code for executing a smoothing process of image data, the code comprising:
an extraction step of extracting a pixel of interest and surrounding pixels thereof from input image data;
a first average value calculation step of calculating an average value of the pixels extracted in the extraction step;
a separation step of separating the pixels extracted in the extraction step into two categories using the average value calculated in the first average value calculation step;
a second average value calculation step of calculating average pixel values of the two categories; and
an output step of outputting a value, which is approximate to a pixel value of the pixel of interest, of the average pixel values of the two categories calculated in the second average value calculation step.

12. A computer-readable medium having computer-executable program code for executing a smoothing process of image data, the code comprising:
an extraction step of extracting a pixel of interest and surrounding pixels thereof from input image data;
a first average value calculation step of calculating an average value of the pixels extracted in the extraction step;
a separation step of separating the pixels extracted in the extraction step into two categories using the average value calculated in the first average value calculation step;
a second average value calculation step of calculating average pixel values of the two categories; and
an output step of outputting a value, which is approximate to a pixel value of the pixel of interest, of the average pixel values of the two categories calculated in the second average value calculation step.
